(19) United States
(12) Patent Application Publication
(10) Pub. No.: US 2005/0094415 A1
(43) Pub. Date: May 5, 2005

(54) Body molding for car

(76) Inventor: Bor-Dong Cheng, Taipei Hsien (TW)

Correspondence Address: PRO-TECHTOR INTERNATIONAL SERVICES, 20775 Norada Court, Saratoga, CA, 95070-3018, US

(21) Appl. No.: 10/697,905

(22) Filed: Oct. 29, 2003

(51) Int. Cl. G02B 6/00

(52) U.S. Cl. 362/551

(57) ABSTRACT

A body molding for car includes a transparent strip formed from an elongate member made of a transparent material. The transparent strip is provided at a rear side with a saw-toothed surface, and at either end with at least one lamp hole for a light source to mount therein. Light having a predetermined color is emitted from the light source and transmitted via the transparent strip to be reflected at the saw-toothed surface toward a front side of the transparent strip, so that the body molding serves not only as a decoration, but also a warning means. A plurality of the body moldings may be arranged to form a shaped member, and have light sources emitting lights of different colors.

### FIELD OF THE INVENTION

The present invention relates to a body molding for car, and more particularly to a body molding for car that not only decorates the car but also emits light to provide a warning effect.

### BACKGROUND OF THE INVENTION

As a nature of human being, people always pursue new and different articles. For example, people want a car that not only has a good structure to serve as a safe means of transportation, but also has an eye-appealing appearance. Therefore, body moldings are frequently mounted on a car as a decoration.

A conventional body molding for car usually includes only a long strip. And, a conventional radiator grille for a car also includes only a plurality of parallelly arranged long bars. The conventional body molding and the radiator grille are only decorations on the car without other additional values and functions.

### SUMMARY OF THE INVENTION

A primary object of the present invention is to provide a body molding for car that not only decorates a car, but also emits light to provide a warning effect.

To achieve the above and other objects, the body molding for car according to the present invention mainly includes a transparent strip formed from an elongate member made of a transparent material. The transparent strip is provided at a rear side with a saw-toothed surface, and at either end with at least one lamp hole for a light source to mount therein. Light having a predetermined color is emitted from the light source and transmitted via the transparent strip to be reflected at the saw-toothed surface toward a front side of the body molding, so that the body molding serves not only as a decoration, but also a warning means.

A plurality of the body moldings may be arranged to form a shaped member, such as a cover for a radiator grille, and have light sources emitting lights of different colors to provide an eye-appealing decoration and an enhanced warning effect at the same time.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a body molding for car according to the present invention;

FIG. 2 is an enlarged sectional view of the circled area A in FIG. 1 showing connection of the body molding to a radiator grille;

FIG. 3 is a sectional view taken along line B-B of FIG. 2; and

FIG. 4 shows the mounting of a plurality of body moldings of the present invention to the radiator grille to form a grille cover.

### DETAILED DESCRIPTION OF THE PREFERRED EMBODIMENTS

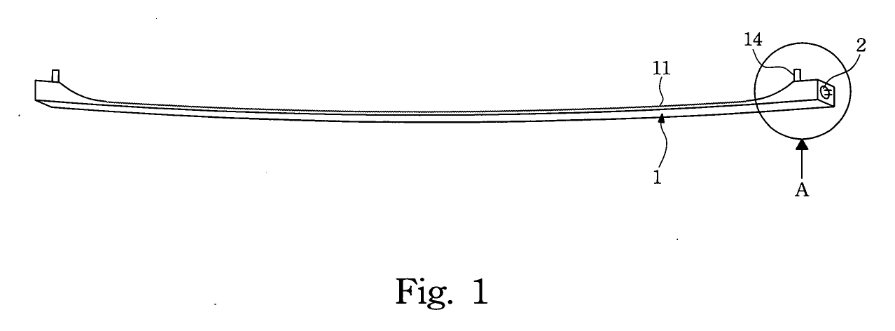

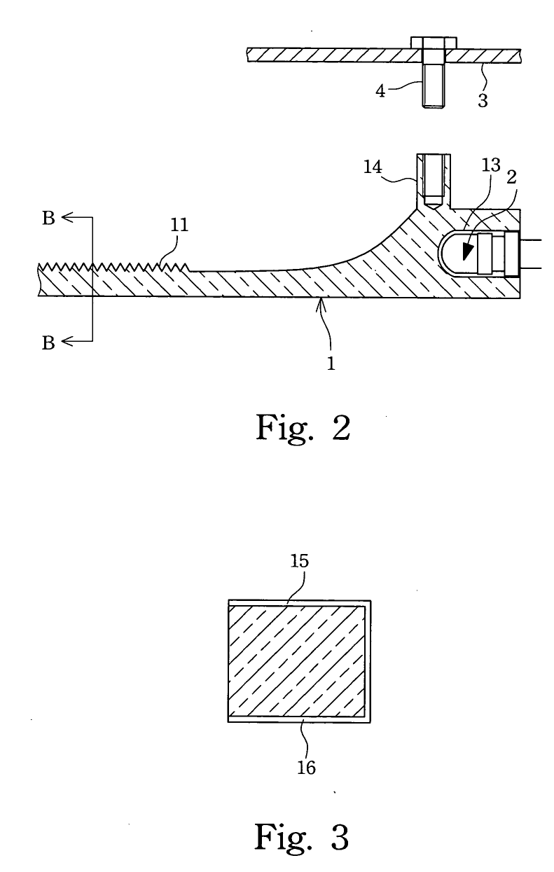

Please refer to FIGS. 1 and 2 that are perspective and partially enlarged sectional views, respectively, of a body molding for car according to the present invention. As shown, the body molding for car includes a transparent strip 1 and at least one light source 2 mounted to one end of the transparent strip 1.

The transparent strip 1 is an elongate member made of a transparent material, which functions like a light-transmitting medium. The transparent strip 1 is provided at a rear side with a saw-toothed surface 11, so as to reflect light projected thereto. At least one lamp hole 13 is provided at an end of the transparent strip 1 for mounting a light source 2 therein. In the illustrated embodiment, both ends of the transparent strip 1 are provided with a lamp hole.

The light source 2 may be, for example, a light emitting diode (LED) inserted in the lamp hole 13 provided at the end of the transparent strip 1.

The transparent strip 1 is provided at the rear side with at least one connecting means, such as an internally threaded stub 14, adapted to connect to a predetermined position on the car, such as a radiator grille 3, by means of a screw 4 threaded into the internally threaded stub 14, as shown in FIG. 2.

When the light source 2 is supplied with a current, light is emitted from the light source 2 and transmitted via the transparent strip 1. When the light reaches at the saw-toothed surface 11 at the rear side of the transparent strip 1, it is guided by the saw-toothed surface 11 to project not only in a forward but also many other different directions, so that the whole transparent strip 1 illuminates in multiple directions to provide a floodlight effect. Therefore, the body molding for car according to the present invention not only serves as a decoration, but also functions like a light-emitting warning means. The light source 2 may be one that emits colored light, so as to create changes in the color of light on the transparent strip 1.

Please refer to FIG. 3. The transparent strip 1 may be further provided at top and bottom surfaces with plating layers 15, 16 to provide a reflection effect, so that light emitted from the light source 2 is prevented from diffusing upward and downward. This enables the transparent strip 1 to illuminate in another manner, in which light is concentrated to shine toward a front side of the transparent strip 1 and therefore provides an enhanced warning effect.

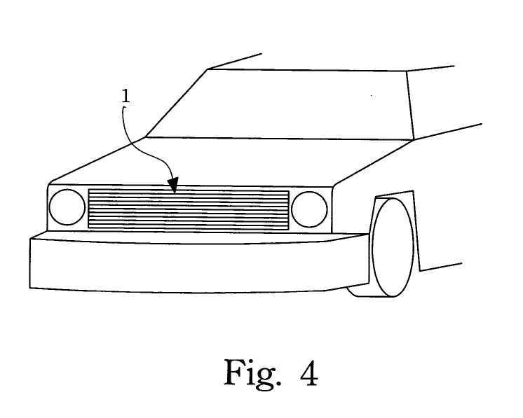

Please refer to FIG. 4. It is also possible to parallelly arrange a plurality of the body moldings of the present invention to form a shaped member, such as a radiator grille cover for fixing to the radiator grille. The plurality of body moldings may be separately provided with light sources emitting lights of different colors. In this case, the body molding is more useful in providing both a dominant warning effect and an eye-appealing decorating effect.

It is also possible to mount a plurality of the body moldings of the present invention on, for example, a rear fender and/or a front bumper (not shown) of the car to decorate and illuminate these areas at the same time.

1. A body molding for car, comprising:
a transparent strip in the form of an elongate member made of a transparent material, said transparent strip being provided at a rear side with a saw-toothed surface, and at either end with at least one lamp hole; and
at least one light source mounted in said lamp hole at one of two ends of said transparent strip.

2. The body molding for car as claimed in claim 1, wherein said light source comprises a light emitting diode (LED).

3. The body molding for car as claimed in claim 1, wherein said transparent strip is provided at top and bottom surface with electric plating layers.

4. The body molding for car as claimed in claim 1, wherein said transparent strip is provided at the rear side with at least one connecting means.

5. The body molding for car as claimed in claim 4, wherein said connecting means comprises an internally threaded stub.

6. The body molding for car as claimed in claim 1, wherein a plurality of said transparent strips are adapted to mount on a radiator grille of said car.

7. The body molding for car as claimed in claim 1, wherein a plurality of said transparent strips are adapted to mount on a rear fender of said car.

8. The body molding for car as claimed in claim 1, wherein a plurality of said transparent strips are adapted to mount on a front bumper of said car.
